(19) United States
(12) Patent Application Publication
(10) Pub. No.: US 2014/0085918 A1
(43) Pub. Date: Mar. 27, 2014

(54) DEVICE FOR INTERIOR LIGHTING IN A MOTOR VEHICLE

(71) Applicants: Wolfgang Muller, Wermelskirchen (DE); Jens Kirch, Burscheid (DE); Oliver Thuma, Erwitte (DE); Yasar Eroglu, Bergneustadt (DE); Jacky Dollsy, Bisten en Lorraine (FR)

(72) Inventors: Wolfgang Muller, Wermelskirchen (DE); Jens Kirch, Burscheid (DE); Oliver Thuma, Erwitte (DE); Yasar Eroglu, Bergneustadt (DE); Jacky Dollsy, Bisten en Lorraine (FR)

(73) Assignee: Johnson Controls Interiors GmbH Co. KG, Grefrath (DE)

(21) Appl. No.: 13/995,003

(22) PCT Filed: Dec. 16, 2011
(86) PCT No.: PCT/EP2011/006381

§ 371 Date: Dec. 2, 2013

(30) Foreign Application Priority Data
Dec. 16, 2010 (DE) 102010054817.0

(51) Int. Cl. B60Q 3/02

(52) U.S. Cl. CPC B60Q 3/0203; B60Q 3/0226
USPC 362/514; 362/516

(57) ABSTRACT

The invention relates to a device for interior lighting in a motor vehicle, wherein the device comprises a lamp, a reflection means and a power distribution means and wherein the lamp, the reflection means and the power distribution means are arranged on a common support structure.

### PRIOR ART

The invention is based on a device for interior lighting in a motor vehicle according to the preamble of claim 1.

Such devices for interior lighting in a motor vehicle are generally known. For example, the printed publication DE 10 2007 057 983 A1 discloses interior lighting in a motor vehicle, the device comprising a group of luminescent diodes (LEDs). The printed publications WO 03/055708 A1 and U.S. 2003/0030063 A1 disclose lighting means for vanity mirrors and the like, which likewise have LEDs.

A disadvantage of the conventional devices for interior lighting is that they are comparatively complex, and therefore expensive, to manufacture. Thus, for example, the group of LEDs from the printed publication DE 10 2007 057 983 A1 is encapsulated in a light-diffusing material, additional production steps being disadvantageously required. Furthermore, conventional devices for interior lighting disadvantageously do not offer the possibility of using both LEDs and incandescent lamps.

It is therefore the object of the present invention to provide a device for interior lighting that can be manufactured comparatively simply and can be used both for LEDs and for incandescent lamps, while using a comparatively large number of identical parts.

### DISCLOSURE OF THE INVENTION

The object is achieved by a device for interior lighting in a motor vehicle which has a lighting means, a reflecting means and a power distributing means, the lighting means, the reflecting means and the power distributing means being arranged on a common supporting structure.

The device according to the invention for interior lighting has the advantage over the prior art that it is comparatively simple, and therefore inexpensive, to manufacture, it being possible for the device to be mounted from just one direction, and that both LEDs and incandescent lamps can be used, while using a comparatively large number of identical parts. This is achieved by the components being arranged on a common supporting structure. In this way, the device can be manufactured in a production process of its own and then mounted as a whole on a component of a motor vehicle, such as for example a sun visor. In particular, it is conceivable that the device can be mounted on different types and configurations of sun visors, so that, in spite of different designs of the sun visors, the same lighting device can be used universally. Furthermore, with the same construction and the same components, different sources of light, i.e. different types of LEDs or incandescent lamps, can be used in a simple way. As a result, the manufacturing costs can be reduced considerably.

Advantageous refinements and developments of the invention can be taken from the description with reference to the drawings.

According to a preferred development, it is provided that the lighting means comprises a light-emitting diode (LED) and/or an incandescent lamp. The light-emitting diode is preferably mounted on a board. In this case, the term lighting means comprises both the light-emitting diode and the board. It is conceivable that an incandescent lamp can also be connected onto the board in addition or as an alternative to the light-emitting diode. The light-emitting diode is preferably designed for emitting light along a direction perpendicular to the board. Advantageously, such light-emitting diodes are more commonly available on the market, and consequently less expensive. Alternatively, it is however also possible to use a light-emitting diode that emits light parallel to the board.

According to a preferred development, it is provided that the supporting structure has at least one fastening and positioning pin, which in particular protrudes perpendicularly from a plate-shaped base region of the supporting structure, the board being fastened to the at least one fastening and positioning pin and extending substantially parallel to the base region. The supporting structure preferably has a plurality of such fastening and positioning pins, so that reliable fastening of the board to the supporting structure is ensured. The fastening and positioning pins preferably keep the board at a distance from the supporting structure, so that the light-emitting diode or the incandescent lamp can be mounted on a side of the board that is facing the supporting structure. This has the advantage that the board at the same time acts as a screen for the light emitted by the light-emitting diode or the incandescent lamp, so that in particular no stray light gets into the region of a mirror, or the holding frame thereof, arranged behind the board. The fastening and positioning pins are in particular formed in one piece with, welded to, clipped together with and/or adhesively bonded to the supporting structure.

According to a preferred development, it is provided that the lighting means is arranged on the board, it being preferred for the board to have a heat-dissipating means, it being particularly preferred for the heat-dissipating means to comprise a copper material. The board preferably comprises a single- or multi-layered, printed circuit board (PCA, Printed Circuit Board). It is particularly preferred for the circuit board to be provided on both sides with a correspondingly formed copper layer. As a result, allowance can be made for different connection geometries of light-emitting diodes of different types and manufacturers. In particular, only one side is ever fitted with components, so that the other side of the board contributes to the removal of heat.

According to another preferred development, it is provided that the lighting means is configured for generating light with a main direction of propagation. This main direction of propagation is preferably aligned perpendicularly in relation to the base region.

According to a preferred development, it is provided that the reflecting means comprises a reflecting bevel, which extends at such an angle from the base region in the direction of the board that the reflecting bevel is inclined with respect to the base region and/or the board. The light-emitting diode is arranged on the board in such a way that light emitted by the light-emitting diode impinges on the reflecting bevel and is directed by the reflecting bevel along a direction parallel to the base region, in the direction of the reflecting region. This makes it possible for the board to be fitted with a comparatively inexpensive light-emitting diode, which emits light perpendicularly in relation to the board in the direction of the base region, since this light is deflected appropriately by means of the reflecting bevel. The reflecting bevel is in particular formed in one piece with the supporting structure. The angle between the reflecting bevel and the base region lies between 15 and 75, with preference between 30 and 60 and with particular preference between 40 and 50 degrees. The board preferably rests on the reflecting bevel.

According to a preferred development, it is provided that the supporting structure comprises a reflecting region, the reflecting region being configured to deflect rays of light that impinge on the reflecting region parallel to the base region into a direction perpendicular to the base region. In an advantageous way, consequently the light directed by the reflecting bevel onto the reflecting region is deflected once again, so that the light can for example be directed onto the rear side of a diffusing lens. Consequently, the light emitted by the light-emitting diode is in particular initially made to pass around the board and then directed into a useful region, in particular in the direction of the interior of the vehicle.

In an alternative embodiment, a light-emitting diode that emits light parallel to the board directly in the direction of the reflecting region is used. In this embodiment, there is no reflecting bevel.

According to another preferred development, it is provided that the power distributing means is formed as a metal leadframe. The power distributing means is connected in an electrically conductive manner to the board by way of at least one plug-in contact extending parallel to the at least one fastening and positioning pin. In an advantageous way, electrical contacting that is comparatively simple, flexible and can be realized inexpensively is achieved by way of the plug-in contact. In particular, in this way mounting of the device from only one mounting direction is made possible. For this purpose, the board fitted with the light-emitting diode is arranged on the fastening and positioning pins in such a way that the fastening and positioning pins engage in bores of the board, the plug-in contacts that are fastened to the board at the same time engaging in the metal leadframe. The mounting direction is consequently aligned perpendicularly in relation to the base region (also referred to as Z mounting). The device according to the invention can consequently be manufactured comparatively simply, quickly and inexpensively. The metal leadframe preferably likewise serves for removing heat from the board by way of the heat-conducting plug-in contacts. It is also conceivable that a spring contact specifically for this is provided between the metal leadframe and the board.

According to another preferred development, it is provided that the board has a central axis, the board being constructed symmetrically in relation to the central axis. With preference, the board has connecting means, with preference bores, for being connected to the supporting structure. It is particularly preferred for the supporting structure to have receiving means, with preference at least one pin, for receiving the connecting means of the board.

According to another preferred development, it is provided that the board has a main plane of extent, the board being arranged with the main plane of extent parallel to a mirror.

According to another preferred development, it is provided that the reflecting means is configured for deflecting the main direction of propagation of the light, the deflection with preference being greater than 45°, with more preference greater than 80°, with particular preference greater than 170°.

The present invention also relates to a sun visor having the device according to the invention and a mirror, the device being arranged on a rear side of the mirror. The lighting means is preferably arranged between the mirror and the supporting structure, it being particularly preferred for the light-emitting diode to be arranged on a side of the board that is facing away from the mirror. In an advantageous way, the light-emitting diode is shielded from the mirror by the board, so that no disturbing stray light gets into the region of the mirror, and consequently cannot unattractively pass through openings between a holding frame holding the mirror and edges of the mirror. The reflecting means in the form of the reflecting bevel is preferably arranged between the lighting means and the supporting structure, so that the light of the light-emitting diode is directed in the direction of the reflecting region.

According to a preferred development, it is provided that the sun visor is formed in such a way that light emitted by the lighting means is radiated mainly in a direction away from the mirror, in the direction of the reflecting means, is directed by the reflecting means into a direction substantially parallel to the base region, in the direction of the reflecting region, and is directed by the reflecting region into a direction substantially perpendicular to the base region, in the direction of a diffusing lens of the sun visor. The diffusing lens is in this case arranged in particular alongside the mirror.

Exemplary embodiments of the present invention are represented in the drawings and are explained in more detail in the description which follows.

### BRIEF DESCRIPTION OF THE DRAWINGS

FIG. 1 shows a schematic view of a device according to an exemplary first embodiment of the present invention and

FIGS. 2 and 3 show a schematic plan view of a device according to an exemplary second embodiment of the present invention.

### EMBODIMENTS OF THE INVENTION

In the various figures, the same parts are always provided with the same reference numerals and are therefore generally also only described or mentioned once in each case.

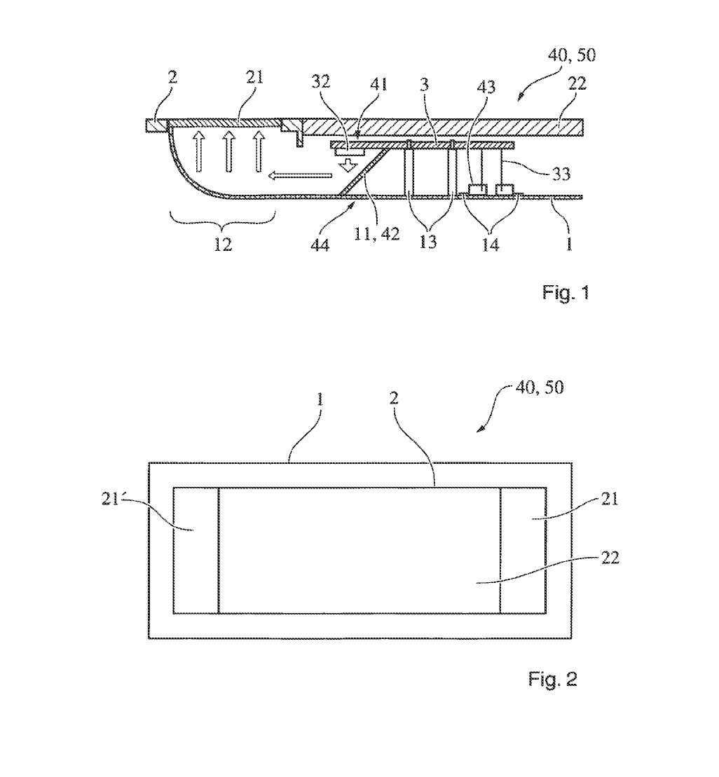

FIG. 1 shows a schematic view of a device 40 according to an exemplary first embodiment of the present invention. A supporting structure 1 or a main reflector body 1 of the device 40 is represented, formed in such a way that the supporting structure 1 or the main reflector body 1 comprises on each side a reflecting bevel 11, a reflecting region 12 and fastening and positioning pins 13 for a board (PCBA) 3. Furthermore, the supporting structure 1 or the main reflector body 1 forms a support for a metal leadframe 14, which serves for power distribution. With preference, the fastening and positioning pin 13 has a bearing surface for bearing the board 3.

In the present example, the device 40 as part of a sun visor 50 is mounted on the rear side of a mirror support 2 of the sun visor 50. The sun visor 50 is intended for use in a motor vehicle. The mirror support 2 forms a frame, which on each side bears a diffusing lens 21 and a central mirror 22. The diffusing lens 21 is intended to direct light diffusely into the interior of the motor vehicle for interior lighting, i.e. also for the indirect lighting of the mirror 22.

Arranged underneath the mirror 22 is the board or PCBA 3. This comprises at least one LED 32 and at least two plug-in contacts 33. The board 3 and the LEDs 32 form the lighting means 41. It is conceivable that, in addition or as an alternative to the LED 32, an incandescent lamp can also be connected onto the board 3. The LED 32 is preferably designed for emitting light from the LED 32 mainly along a direction perpendicular to the board 3, and to a base region 44 of the supporting structure 1 formed as a plate, in the direction of the base region 44. Such LEDs 32 are more commonly found, and consequently less expensive.

The LED 32 lights up a reflecting means 42 in the form of the reflecting bevel 11. The light impinging on the reflecting bevel 11 is reflected by the reflecting bevel 11 in the direction of the reflecting region 12 of the supporting structure 1 or of the main reflector body 1. The light is thereby deflected by the reflecting bevel 11 from the direction of propagation running substantially perpendicularly in relation to the base region 44 into a direction of propagation running substantially parallel to the base region 44. In the reflecting region 12, the light is deflected in the direction of the diffusing lens 21. This type of light diffusion has the effect of achieving improved homogeneity of the light on the diffusing lens 21.

The device 40 is therefore formed in such a way that light emitted by the LED 32 is radiated mainly in a direction away from the mirror 22, in the direction of the reflecting means 42, is directed by the reflecting means 42 into a direction substantially parallel to the base region 44, in the direction of the reflecting region 12, and is directed by the reflecting region 12 into a direction substantially perpendicular to the base region 44, in the direction of a diffusing lens 21. The light of the LED 32 is consequently partially directed around the mirror 22 and the mirror 22 is shielded from stray light by means of the board 3.

It is preferred for the board 3 to be designed as a double-sided conductive surface, which is at least partially coated on both sides with a copper material. The fitting of components on the board 3, for example the LED 32, only takes place on one side. The other side advantageously makes comparatively good removal of heat possible. It is preferred for the board 3 to be of a symmetrical configuration. As a result, it is advantageously possible that both conductor surfaces (of copper material) are suitable for supporting the LED 32 and other necessary components, such as for example electrical and/or electronic components. Furthermore, it is advantageously possible that LEDs 32 of different manufacturers and types can be applied to the board 3. It is further preferred for each conductor surface of the board 3 to have at least three different positions at which an LED 32 can be positioned. It is advantageously possible that one LED 32 or two LEDs 32 may be attached on each conductor surface.

It is particularly preferred for the board 3 to have at least three bores 101. In the present embodiment, the board 3 has four bores 101. The at least one fastening and positioning pin 13 engages through these bores 101. It is preferred for the board 3 to rest on the reflecting bevel 11. The LED 32 emits light in the direction of the reflecting bevel 11, so that advantageously no stray light can emerge from between the mirror 22 and the mirror frame 2.

It is advantageously possible that the device 40 can be mounted from only a single direction (for example Z mounting), it being preferred for the device to be able to be mounted from “above”, i.e. from the direction of the perpendicular to the plane of main extent of the device 40. For this, the board 3 fitted with the LED 32 is arranged on the fastening and positioning pins 13 in such a way that the fastening and positioning pins 13 engage in the bores 101 of the board 3 and the board 3 rests on bearing surfaces of the fastening and positioning pins 13. At the same time, the plug-in contacts 33 fastened on the board 3 thereby engage in openings in the metal leadframe 14, so that an electrical contact is established between the board 3 and the metal leadframe 14. The LED 32 is supplied with power by way of this electrical contact.

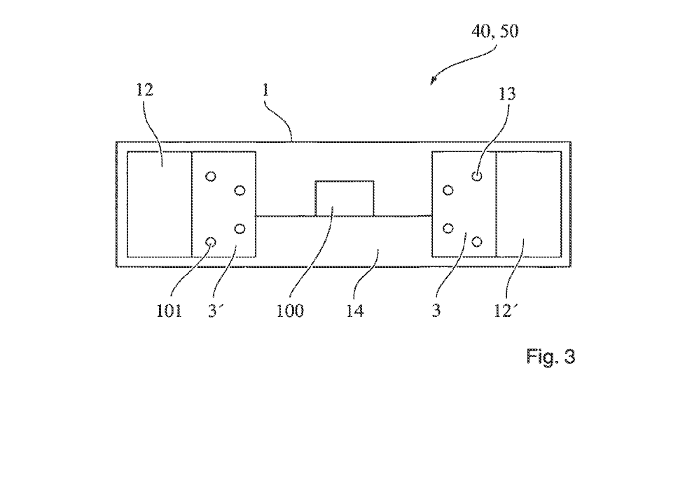

FIG. 2 schematically shows a plan view of a device 40 according to an exemplary second embodiment of the device according to the invention. The second embodiment is substantially the same as the first embodiment, illustrated in FIG. 1, though two diffusing lenses 21, 21′ are represented in FIG. 2. Arranged between the diffusing lenses 21, 21′ is the mirror 22. The device 40 has in turn the supporting structure 1 or the main reflector body 1. The supporting structure 1 forms the support for the mirror frame 2, the mirror 22 and the diffusing lenses 21, 21′. The board 3, 3′, the reflecting means 42 and the power distributing means 43 cannot be seen for reasons of perspective.

FIG. 3 schematically shows the embodiment from FIG. 2 without the mirror frame 2, the mirror 22 and the diffusing lens 21. The device 40 has the supporting structure 1 with at least one fastening and positioning pin 13. The supporting structure 1 supports the boards 3, 3′, fitted with LEDs 32, a switch 100 and the metal leadframe 14. Furthermore, the supporting structure 1 has the reflecting regions 12, 12′. The boards 3, 3′ respectively have at least one bore 101 for receiving one of the fastening and positioning pins 13. The LEDs 32 are arranged on the underside of the boards 3, 3′ and therefore cannot be seen in FIG. 3 for reasons of perspective. The same applies to the reflecting means 42, which in FIG. 3 are concealed by the boards 3, 3′.

### LIST OF REFERENCE SIGNS

1 supporting structure, main reflector body

2 mirror frame

3, 3′ board

11, 11′ reflecting bevel

12, 12′ reflecting region

13 fastening and positioning pin

14 metal leadframe

21, 21′ diffusing lens

22 mirror

32 LED

33 plug-in contact

40 device

41 lighting means

42 reflecting means

43 power distributing means

44 base region

50 sun visor

100 switch

101 bore

1.-13. (canceled)

14. A device for interior lighting in a motor vehicle, comprising a lighting means, a reflecting means and a power distributing means, wherein the lighting means, the reflecting means and the power distributing means are arranged on a common supporting structure.

15. The device as claimed in claim 14, wherein the lighting means comprises a light-emitting diode and/or an incandescent lamp and/or the lighting means comprises a board and a light-emitting diode and/or an incandescent lamp arranged on the board.

16. The device as claimed in claim 15, wherein the supporting structure comprises at least one fastening and positioning pin protruding perpendicularly from a plate-shaped base region of the supporting structure, the board being fastened to the at least one fastening and positioning pin and extending substantially parallel to the base region.

17. The device as claimed in claim 16, wherein the reflecting means comprises a reflecting bevel extending at such an angle from the base region in the direction of the board that the reflecting bevel is inclined with respect to the base region and/or the board.

18. The device as claimed in claim 16, wherein the supporting structure comprises a reflecting region configured to deflect rays of light that impinge on the reflecting region parallel to the base region into a direction perpendicular to the base region.

19. The device as claimed in claim 18, wherein the light-emitting diode is arranged on the board in such a way that light emitted by the light-emitting diode impinges on the reflecting bevel and is directed by the reflecting bevel along a direction parallel to the base region, in the direction of the reflecting region.

20. The device as claimed in claim 15, wherein the board comprises a heat-dissipating means.

21. The device as claimed in claim 16, wherein the power distributing means comprises a metal leadframe and/or the power distributing means is connected in an electrically conductive manner to the board by at least one plug-in contact extending parallel to the at least one fastening and positioning pin.

22. A sun visor comprising a device as claimed in claim 1, and a mirror, the device being arranged on a rear side of the mirror.

23. The sun visor as claimed in claim 22, wherein the lighting means is arranged between the mirror and the supporting structure and the reflecting means is arranged between the lighting means and the supporting structure.

24. The sun visor as claimed in claim 22, wherein the sun visor is formed in such a way that light emitted by the lighting means is radiated mainly in a direction away from the mirror, in the direction of the reflecting means, is directed by the reflecting means into a direction substantially parallel to a base region, in the direction of a reflecting region, and is directed by the reflecting region into a direction substantially perpendicular to the base region, in the direction of a diffusing lens of the sun visor.

25. The sun visor as claimed in claim 24, wherein the diffusing lens is arranged alongside the mirror.

26. The device as claimed in claim 17, wherein the board rests on the reflecting bevel.

27. The device as claimed in claim 20, wherein the heat-dissipating means is arranged at least on a side of the board facing away from the supporting structure.

28. The device as claimed in claim 20, wherein the heat-dissipating means comprises a copper material.
